(19) United States
(12) Patent Application Publication
(10) Pub. No.: US 2023/0167921 A1
(43) Pub. Date: Jun. 1, 2023

(54) LONG ARTICLE MANAGEMENT CONDUIT AND METHOD FOR PRODUCING THE SAME

(71) Applicant: STIRLING MOULDED COMPOSITES LIMITED, Padiham Lancashire (GB)

(72) Inventor: Sophie Bellamy TAYLOR, Padiham Lancashire (GB)

(73) Assignee: STIRLING MOULDED COMPOSITES LIMITED, Padiham Lancashire (GB)

(21) Appl. No.: 17/997,985

(22) PCT Filed: Apr. 30, 2021
(86) PCT No.: PCT/EP2021/061469

§ 371 Date: Nov. 4, 2022

(30) Foreign Application Priority Data
May 4, 2020 (GB) 2006557.9

(51) Int. Cl. F16L 3/10; F16L 3/015

(52) U.S. Cl. CPC F16L 3/1066; F16L 3/015; F16L 3/1058; F16L 3/26

(57) ABSTRACT

The present invention is concerned with a long article management conduit with a split part extending in a longitudinal direction. The conduit includes a plurality of hoops, each having first and second ends so as to have a discontinuous portion at the split part, and arranged side by side with a spacing therebetween in the longitudinal direction.

### CROSS REFERENCE TO RELATED APPLICATION

This application is a U.S. National Stage Application under 35 U.S.C. § 371 of International Application No. PCT/EP2021/061469, filed Apr. 30, 2021, and claims the benefit of United Kingdom Patent Application No. GB 2006557.9, filed May 4, 2020, the entire contents all of which is hereby incorporated by reference in their entirety.

### BACKGROUND OF THE DISCLOSURE

### 1. Field of the Disclosure

This invention relates generally to a long article management conduit, and a method for producing the same.

### 2. Description of the Related Art

Long article management conduits are used to bundle a plurality of long articles such as cables and pipes. These conduits provide not only well organised appearance for the plurality of long articles but also protection of the long articles from external stress such as friction, vibration, and ultraviolet rays.

One example is shown in United States Design Patent No. 778,841. This prior art document shows a cable organiser which has almost cylindrical shape with a split part continuously extending in a longitudinal direction. Cables can be inserted through the split part by enlarging this part against the resistive force from the cylindrical wall of the cable organiser. The cable organiser shown in this prior art document, however, requires a strong force to expand and open the split part because the hard cylindrical wall continuously extends in the longitudinal direction. Further, the continuously extending wall increases material amount to be used and thus increases the cost. Furthermore, the continuously extending wall with almost no bending flexibility provides a very low degree of freedom in arrangement of such cable organisers.

Thus, it is an object of this invention to provide long article management conduits that overcome the drawbacks of the prior art.

### SUMMARY

An aspect of the invention relates to a long article management conduit with a split part extending in a longitudinal direction thereof, comprising a plurality of hoops, each having first and second ends so as to have a discontinuous portion at the split part, and arranged side by side with a spacing therebetween in the longitudinal direction.

Preferably, the long article management conduit further comprises one or more membranes attached on outer and/or inner surface of the hoops so that the hoops are linked to each other in series in the longitudinal direction.

In an example embodiment, the long article management conduit, with or without the one or more membranes, further comprises: a plurality of first connecting webs which connect every other set of two first ends adjacent to each other in the longitudinal direction; and a plurality of second connecting webs which connects every other set of two second ends adjacent to each other in the longitudinal. Accordingly, the first connecting web and the second connecting web are located alternately in the longitudinal direction, and said spacing is provided between the hoops adjacent to each other in the longitudinal direction.

Preferably, the first connecting web and the second connecting web overlap each other when viewed in the longitudinal direction.

In some example embodiments having the one or more membranes, the membrane is bonded or welded to the hoops. Alternatively or additionally, the membrane may be fastened to the hoops with fasteners such as clips, rivets, hook, loops, sewing. However, the hoops may be loosely held in pockets formed between two laminated membranes so as to fully receive the hoops. These membranes may be bonded, welded or sewn together excluding the areas of the pockets.

In an example embodiment, each of the hoops includes one or more hooks so that the membrane is detachably attached to the hoops thereby.

In some example embodiments, each of the hoops is made of thermoplastic resin. The thermoplastic resin may be selected from polyethylene (PE), polypropylene (PP), polyvinyl chloride (PVC), polystyrene (PS), or polytetrafluoroethylene (PTFE), or the like. The thermoplastic resin may be fibre-reinforced thermoplastic resin. In other example embodiment, the hoop is made of biodegradable plastics or plant based resins, etc.

In some example embodiments, each of the hoops is a formed piece. The “formed piece” is a piece formed from a flat plate piece into a hoop shape by bending work. The hoop may be a pre-formed piece which already has the hoop shape when attached to the membrane.

In some example embodiments, the first and second ends of each of the hoops overlap each other in a circumferential direction. The overlap distance is preferably at least 3 mm, more preferably 5 mm, yet more preferably 8 mm so that long articles received inside the conduit are completely covered when the hoops are closed. The overlap distance is preferably less than 15 mm, more preferably less than 13 mm, yet more preferably 10 mm or at most 8 mm so that the discontinuous portion can be easily opened when the force is applied to the conduit to open the split part by a user. However, in other applications the overlap distance may be reduced, or the first and second ends of the hoop may be separated from each other in the close state where no force is applied to the conduit to open at the split part.

In some example embodiments, the dimension of each of the hoops measured in the longitudinal direction is in the range of 10% to 200% of the diameter or widest width of the conduit.

In some example embodiments, the dimension of each of the hoops measured in the longitudinal direction decreases toward the first and second ends. In other example embodiments, the dimension of the hoops can differ along the longitudinal length of the long article management conduit. In some instances the hoops are not regular in shape and/or size, or even regular with each other. The hoops can have different widths and different spaces apart within the same long article management conduit.

In some example embodiments, at least one hoop has one or more openings, one or more cutouts, and/or one or more thinned wall portions. The opening may have a similar geometry to the contour of the hoop.

In some example embodiments, each or some of the hoops includes one or more reinforcing ribs.

In some example embodiments, the membrane is made of fabric or non-woven fabric comprising natural or synthetic fibre, paper, synthetic resin film, or artificial or natural leather.

In some example embodiments, the membranes are provided on the outer and/or inner surface of each hoop.

In some example embodiments, one or both edges of the membrane at the split part are folded to cover the first and/or second ends of each hoop. Alternatively or additionally, one or both edges of the membrane at the split part are covered with covering strips.

In some example embodiments, one or both edges of the membrane at the split part are finished with a sewn hem.

In some example embodiments, one or both edges of the membrane at the split part include a plurality of pockets into which the first and/or second ends of the hoops, or the entire hoop, are inserted.

The preferred spacing between the hoops may depend on the size of the conduit. In some example embodiments, the spacing is in the range of 1 to 200% of the diameter or the widest width of the conduit. The spacing may be in the range of 0.5 to 100 mm, preferably 5 to 15 mm, more preferably 8 to 12 mm.

In some example embodiments, the plurality of hoops are resiliently deformable.

Another aspect of the invention relates to a method for producing a long article management conduit with a split part continuously extending in a longitudinal direction thereof. The method comprising steps of: providing a plurality of flat plate pieces; arranging the plurality of flat plate pieces on a first membrane side by side with a spacing therebetween in a direction which is to be the longitudinal direction; bonding, welding, sewing, or fastening the flat plate pieces to the first membrane; and creating a plurality of hoops by forming the flat plate pieces into hoop shapes around said direction which is to be the longitudinal direction.

In an example embodiment, the method further comprises steps of: arranging a second membrane over the first membrane so that the plurality of the flat plate pieces are between the first and second membranes; and bonding, welding, sewing or fastening the second membrane to the flat plate pieces.

In some example embodiments, the forming step is performed during the bonding or welding step.

In some example embodiments, the plurality of hoops are resiliently deformable.

Yet another aspect of the invention relates to a method for producing a long article management conduit with a split part continuously extending in a longitudinal direction thereof. The method comprises steps of: providing a plurality of pre-formed hoops, each having first and second ends so as to have a discontinuous portion; and detachably attaching the pre-formed hoops onto a membrane so that the pre-formed hoops are arranged side by side with a spacing therebetween in a direction which is to be the longitudinal direction, thereby the pre-formed hoops are linked to each other in series in the longitudinal direction.

In an example embodiment, the pre-formed hoops includes one or more hooks, and the membrane includes one or more holes into which the hooks are inserted.

In some example embodiments, the plurality of pre-formed hoops are resiliently deformable.

Yet another aspect of the invention relates to a method for producing a long article management conduit with a split part continuously extending in a longitudinal direction thereof. The method comprises steps of providing a flat strip which extends in a meander-like fashion and thus has a plurality of turning points on both sides, and creating a plurality of hoops by forming the flat strip into a hoop shape around the longitudinal direction so that the turning points on one side and the turning points on the other side are located alternately in the longitudinal direction.

### BRIEF DESCRIPTION OF THE DRAWINGS

The principle and advantages of the present invention will now be more fully described in the following detailed description taken with the accompanying drawings, in which:

FIG. 1 is a perspective view of a long article management conduit with a generally rectangular cross section, according to an embodiment of the present invention.

FIG. 2A is a perspective view of the hoops of the long article management conduit of FIG. 1.

FIG. 2B is an expanded view of the hoop which locates at ends in the longitudinal direction of the long article management conduit.

FIG. 2C is an expanded view of the hoop which locates between the both ends in the longitudinal direction of the long article management conduit.

FIG. 3 is a side view of the long article management conduit of FIG. 1.

FIG. 4 is a cross-section view of the long article management conduit of FIG. 1 taken along line IV-IV in FIG. 3.

FIG. 5 is a perspective view of the long article management conduit of FIG. 1 in the bending state.

FIG. 6 is a perspective view of a variation of the long article management conduit of FIG. 1, with a generally circular cross section.

FIG. 7 is a side view of the long article management conduit of FIG. 6.

FIG. 8 is a cross-section view of the long article management conduit of FIG. 7 taken along line VIII-VIII in FIG. 7.

FIG. 9 is a perspective view of a long article management conduit according to an embodiment of the present invention.

FIG. 10A is a perspective view of unformed flat plate pieces with openings for constructing a long article management conduit according to an embodiment of the present invention.

FIG. 10B is a perspective view of formed hoops from the flat plate pieces of FIG. 10A.

FIG. 11A is a perspective view of a long article management conduit having irregular shaped hoops in series in the longitudinal direction, according to an embodiment of the invention.

FIG. 11B is a front view of the long article management conduit of FIG. 11A.

FIG. 12 is a front view of a long article management conduit according to an embodiment of the present invention.

FIG. 13 is a side view of the long article management conduit of FIG. 12.

FIG. 14 is a cross-section view of the long article management conduit of FIG. 12 taken along line XIV-XIV in FIG. 13.

FIG. 15 shows a backside of a membrane removed from the long article management conduit of FIG. 12.

FIGS. 16A, 16B, 16C, 16D, 16E, and 16F illustrate a method for producing the long article management of FIG. 1, according to an embodiment of the present invention.

FIG. 17A shows a perspective view of a long article management conduit of another embodiment according to the invention.

FIG. 17B shows a top view of the long article management conduit of FIG. 17A.

FIG. 18 shows a plan view of an unformed flat strip used for producing the conduit shown in FIGS. 17A and 17B.

### DETAILED DESCRIPTION

At the outset, it should be appreciated that like reference numbers appearing in different drawings identify identical, or functionally similar, structural elements. Furthermore, it is understood that this invention is not limited only to the particular embodiments, methodology, materials and modifications described herein.

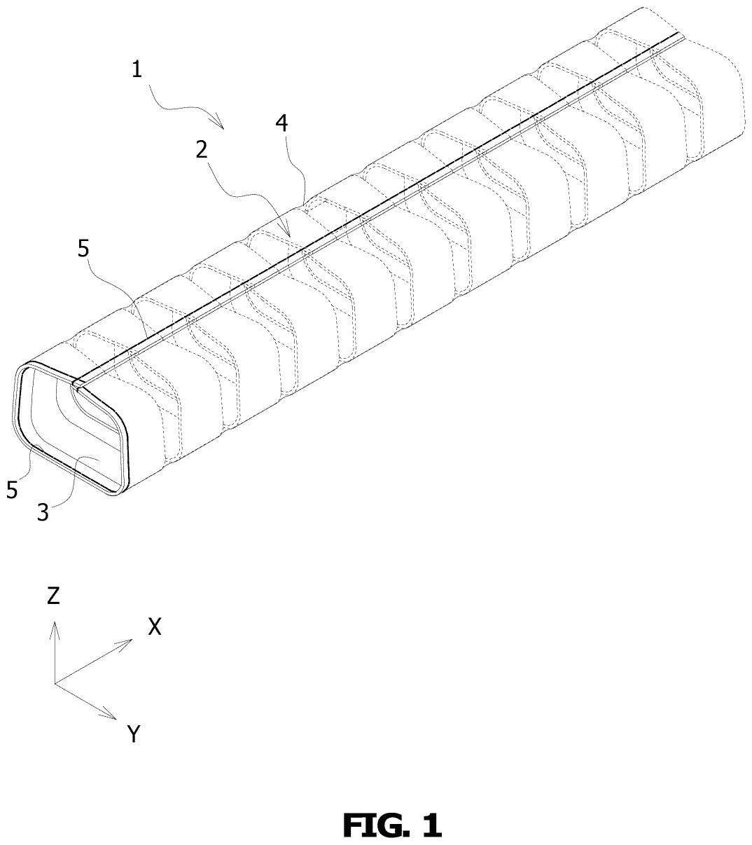

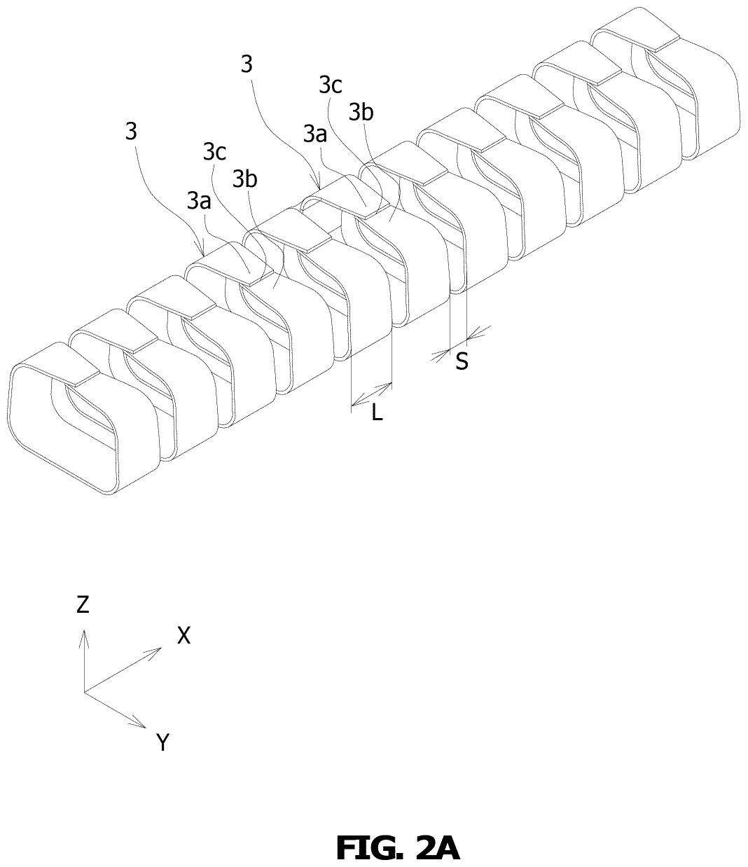

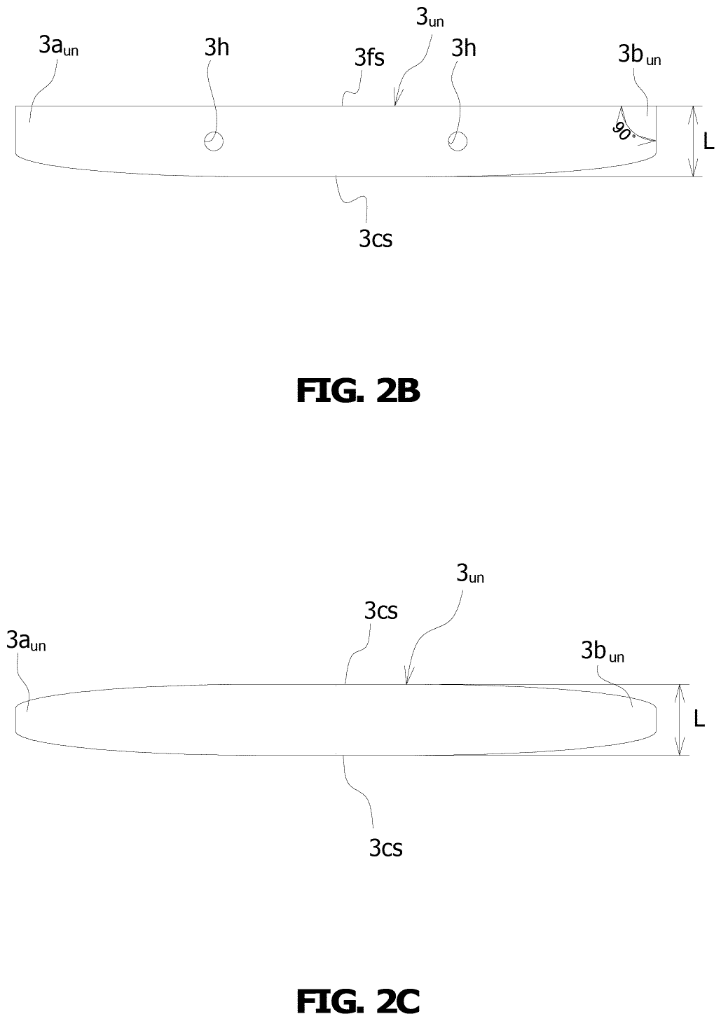

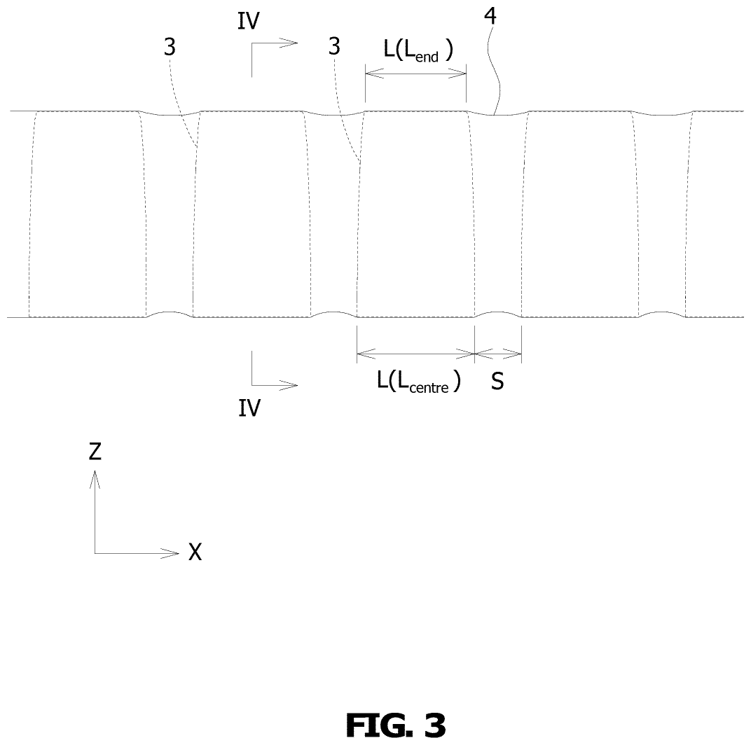

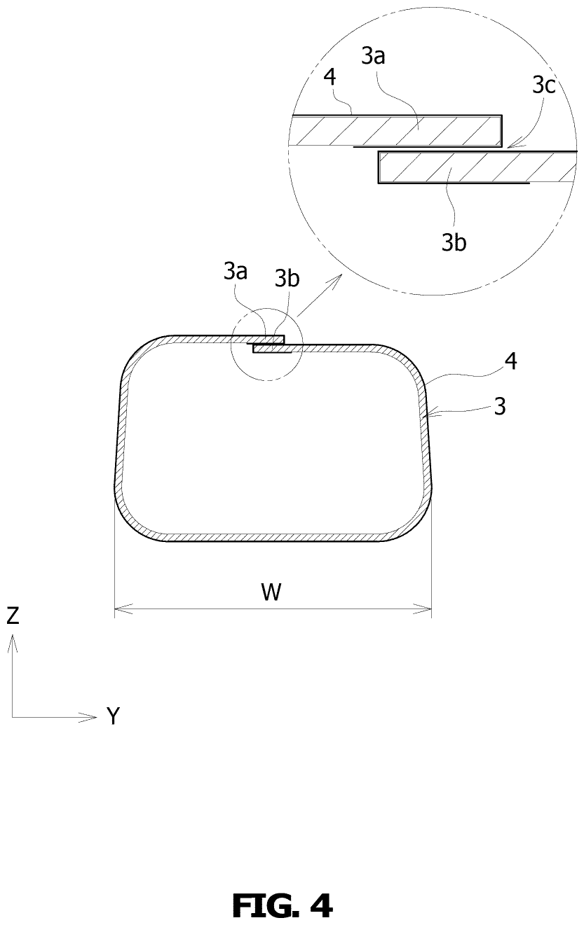

The following description is made with reference to FIGS. 1 to 5. FIG. 1 is a perspective view of a long article management conduit with a generally rectangular cross section, according to an embodiment of the present invention. FIG. 2A is a perspective view of hoops of the long article management conduit of FIG. 1. FIG. 3 is a side view of the long article management conduit of FIG. 1. FIG. 4 is a cross-section view of the long article management conduit of FIG. 1 taken along line IV-IV in FIG. 3.

The long article management conduit 1 may be used for bundling up and managing a plurality of long articles such as cables and pipes but also any other thread like or long fibres which may need grouping for example. The conduit 1 has a split part 2 extending in a longitudinal direction X of the conduit 1. Preferably, the split part 2 continuously extends in the direction X. Long articles can be inserted through the split part 2 by enlarging and opening the split part 2. The conduit 1 mainly comprises a plurality of hoops 3 and a membrane 4. The hoops 3 can be resiliently deformed to allow passage of the long article into the conduit 1 through the split part 2. The hoops 3 are arranged side by side with a spacing S therebetween in the longitudinal direction X. The spacing S does not need to be uniform but can vary throughout the length of the conduit 1. The membrane 4 is attached on the outer surfaces of the hoops 3 so that the hoops 3 are linked to each other in series in the longitudinal direction X. Additionally or alternatively, a second membrane (not shown) may be attached on the inner surfaces of the hoops 3.

Each hoop 3 may be a formed piece which is formed during or after attaching the membrane 4. However, the hoop 3 may be a pre-formed piece which has been already formed before attaching the membrane 4. The hoop 3 may be formed by bending or pressing. The hoop 3 may be made by injection moulding, 3D printing, or the like. The hoop 3 has first and second ends 3a, 3b so as to have a discontinuous portion 3c. The “discontinuous portion” is the separating portion between the first and second ends 3a, 3b in the hoop 3.

Each hoop 3 has a nearly rectangular shape in this example, but other tube shapes may be applicable such as circle, oval, triangle, pentagon, hexagon, octagon or other including non-regular shapes.

Also, the expanded shape of the hoop 3, which has substantially the same form as an unformed flat plate piece 3ᵤₙ as discussed later, is not limited to a rectangle. FIG. 2B is an expanded view of the hoop which locates at ends in the longitudinal direction of the long article management conduit. In this example, the unformed flat plate piece 3ᵤₙ to be the hoop 3 which locates at the axial ends of the conduit 1 has a flat side 3fs and a curved side 3cs. The flat side 3fs is arranged on the axially outside in the longitudinal direction so that a straight hem 5 can be easily created on the axial ends of the conduit 1. These unformed flat plate piece 3ᵤₙ may also include one or more though holes 3h in order to attach a fastener after the unformed flat plate piece 3ᵤₙ has been formed. The curved side 3cs may curve so that the dimension L in the direction X decreases toward its width ends 3aᵤₙ, 3bᵤₙ.

FIG. 2C is an expanded shape of the hoop 3 which locates between the axially both ends of the conduit 1. In this example, the unformed flat plate piece 3un to be the hoop 3 which locates between the axial ends of the conduit 1 has opposing curved sides 3cs. The curved sides 3cs may curve so that the dimension L in the direction X decreases toward its width ends 3aᵤₙ, 3bᵤₙ.

The discontinuous portion 3c can be opened when the hoop 3 is forced to expand outside by a user. To this end, each hoop 3 is made from elastic material. The hoop 3 may be made from thermoplastic resin. The thermoplastic resin may be selected from polyethylene (PE), polypropylene (PP), polyvinyl chloride (PVC), polystyrene (PS), or polytetrafluoroethylene (PTFE), or the like. The thermoplastic resin may be fibre-reinforced thermoplastic resin. However, the hoop 3 may be made from any other material such as non-woven material, metal, plant-based and recycled plastics. The hoop 3 may include one or more reinforcing ribs (not shown in this example).

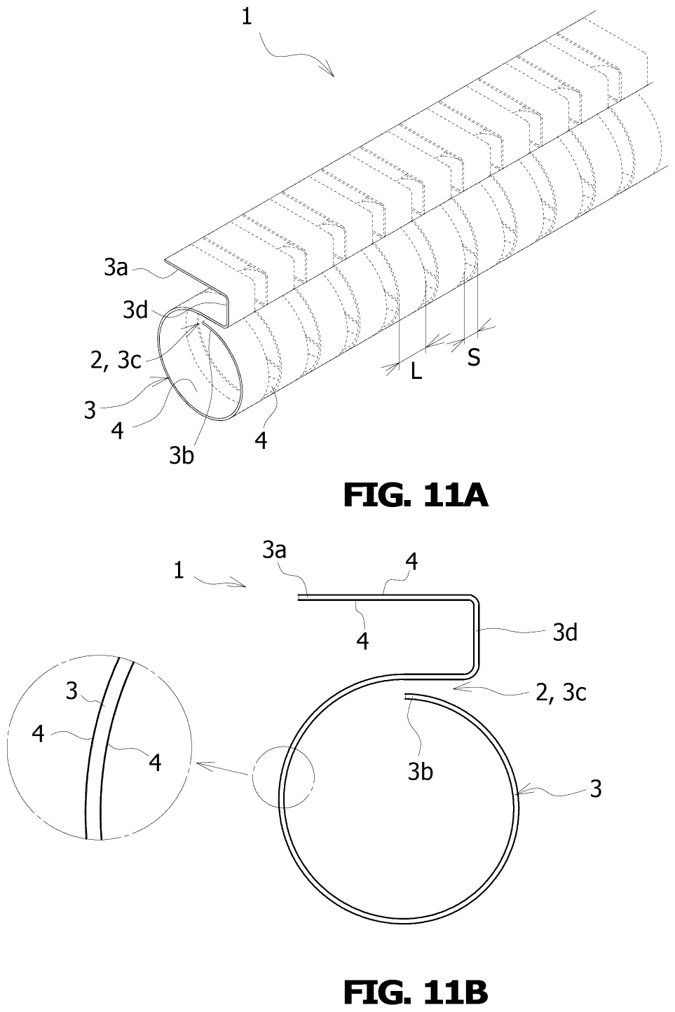

The first and second ends 3a, 3b of the hoop 3 may overlap each other in the circumferential direction in the closed state where the force to enlarge the discontinuous portion 3c is not applied. The width ends 3a, 3b may alternately overlap each other in the longitudinal direction X. That is, in one of the axially adjacent hoops 3, the first end 3a may extend over the second end 3b; in the other of the axially adjacent hoops 3, the first end 3a may extend under the second end 3b. The overlap distance is preferably at least 3 mm, more preferably at least 5 mm, yet more preferably at least 8 mm so that long articles received inside the conduit 1 are completely covered and protected when the hoops 3 are closed. The overlap distance is preferably less than 15 mm, more preferably less than 13 mm, or at most 10 mm so that the discontinuous portion 3c can be easily opened when the force is applied to the conduit 1 to open the split part 2 by a user. The overlap does not necessary to be created by the first and second ends 3a, 3b. The overlap may be provided at any point along the hoop 3 (one example can be seen in FIGS. 11A and 11B).

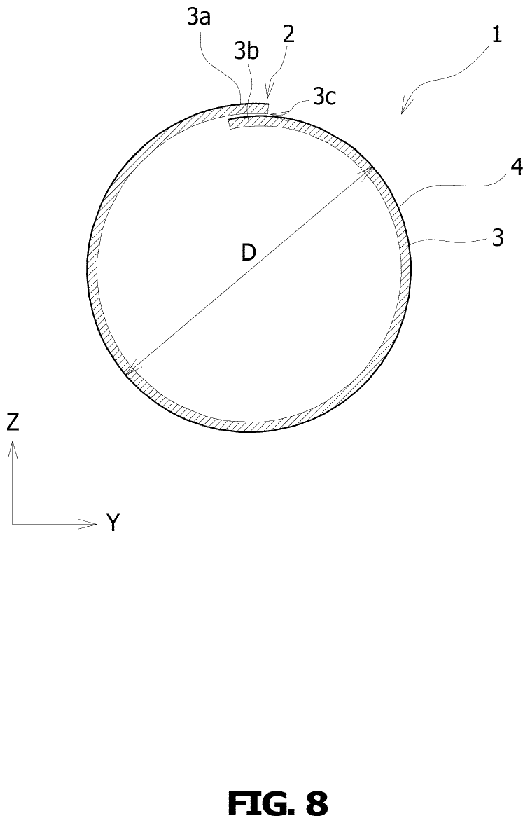

The dimension L (minimum dimension) of each of the hoops 3 measured in the longitudinal direction X may be in the range of 10% to 200% of width W (maximum width) or the diameter D (maximum diameter, see FIG. 8) of the conduit 1.

Keeping the dimension L of the hoop 3 within this range contributes to a sufficient strength of the conduit 1 and thus a desired shape of the conduit 1 will be kept in use. The spacing S and/or the dimension L may vary along the length of the conduit 1 to either increase or decrease its flexibility.

The dimension L may at least partially decrease toward the first and second ends 3a, 3b of the hoop 3. Each hoop 3 may be tapered from the centre to the outside ends 3a, 3b (L_{end}<L_{centre}). This allows for an increased flexibility in one direction, thereby facilitating opening of the ends 3a, 3b of hoop 3.

Also, preferred spacing S between the axially adjacent hoops 3 depends on the size of the conduit 1. The spacing S may be in the rang of 1% to 200% of the width W (maximum width) or diameter D (maximum diameter, see FIG. 8) of the conduit 1. The spacing S may be in the range of 0.5 to 100 mm, preferably 5 to 15 mm, more preferably 8 to 10 mm. In one example, for a conduit of 60 mm×30 mm with a hoop depth (dimension L) 25 mm, there may be a spacing S of 8 mm to 12 mm.

Keeping the spacing S value within the ranges of this invention contributes to a sufficient bending flexibility of the conduit 1. Particularly, if the spacing S is much smaller than the aforementioned ranges, such as less than 1 mm, the axially adjacent hoops 3 may contact each other soon after the bending starts so that the conduit 1 is restricted so as not to sufficiently bend. However, such a small spacing S may be intentional in some examples in order to restrict flexibility in some areas.

The cross-sectional size of the conduit 1 may depend on its intended use. For a cable management conduit the cross-sectional area may be of 200 mm² to 5000 mm². However, larger cross-sectional areas can be used for pipe management, workshop and machine tools, and other management where long articles need protection whilst in a dynamic state. Much smaller cross-sectional areas may also be used for conduits for use in harnesses worn by persons such as fire-fighters, and the like to protect breathing tubes and electric cables.

Turning now to the membrane 4, it may be bonded to the hoops 3. Any adhesive suitable for bonding the membrane 4 to the hoops 3 may be used. The adhesive may be selected from a pressure-sensitive adhesive, a thermosetting adhesive, a hot-melt adhesive, an ordinary temperature hardening type adhesive, or the like. Additionally or alternatively, the membrane 4 may be welded to the hoops 3 by laser welding, ultrasonic welding, or heating within a forming die, or hot plate, or heat welding by any means, for example.

Any sheet-like or film-like material having a predetermined tensile strength capable of standing the bending is used for the membrane 4. The membrane 4 may be made of fabric or non-woven fabric comprising natural or synthetic fibre, paper, synthetic resin film, or artificial or natural leather. Any surface treatment may be applied onto the surface of the membrane 4 and/or the surface of the membrane 4 may be coated in order to provide protections such as waterproofing and fire resistance. Stretchable fabric in at least one direction, preferably in two directions, is preferred for the membrane 4.

One or both width edges of the membrane 4 at the split part 2 may be finished with a sewn hem 5 (FIG. 1). Particularly, one or both edges of the membrane 4 at the split part 2 may be folded around the first and second ends 3a, 3b of the hoops 3, and sewn together with these ends 3a, 3b along the split part 2. Additionally or alternatively, one or both edges of the membrane 4 at the split part 2 may be covered with covering strips (not shown). The covering strip may be sewn together with the membrane 4 and the hoops 3. The covering strip may include zips, Velcro®, and the like. One or both axial ends of the membrane 4 may also be finished with a sewn hem 5.

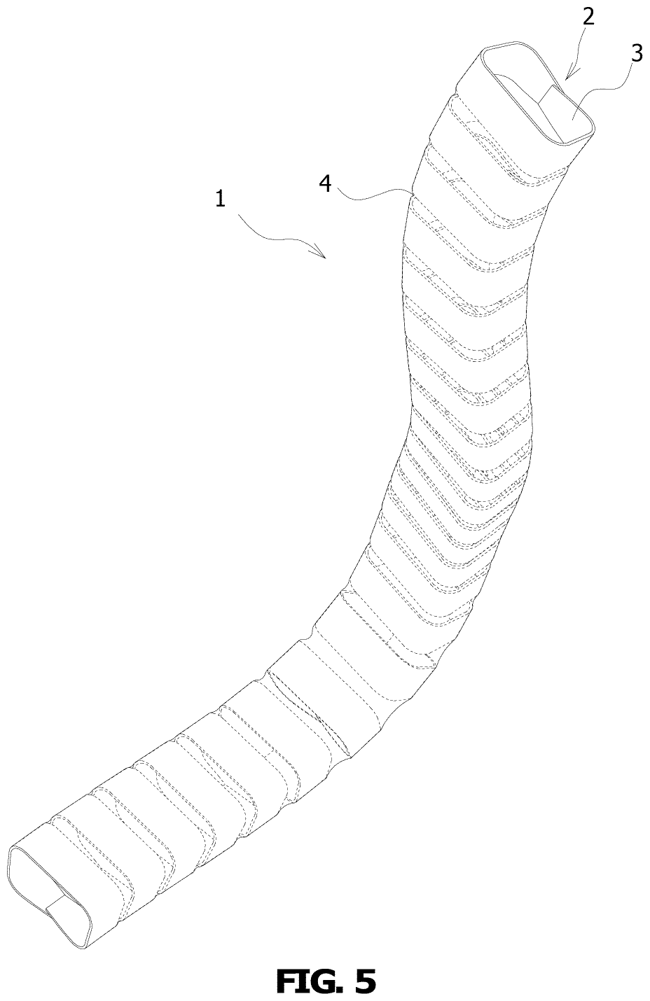

FIG. 5 shows the long article management conduit 1 of FIG. 1 in the bending state. It can be clearly seen that the conduit 1 has sufficient flexibility on the basis of the spacing S between the axially adjacent hoops 3. In addition, with less material usage at the spacing S, the conduit 1 is significantly lighter than the prior art cable organiser which has the hard cylindrical wall continuously extending in the longitudinal direction, and thus may be manufactured at a low cost.

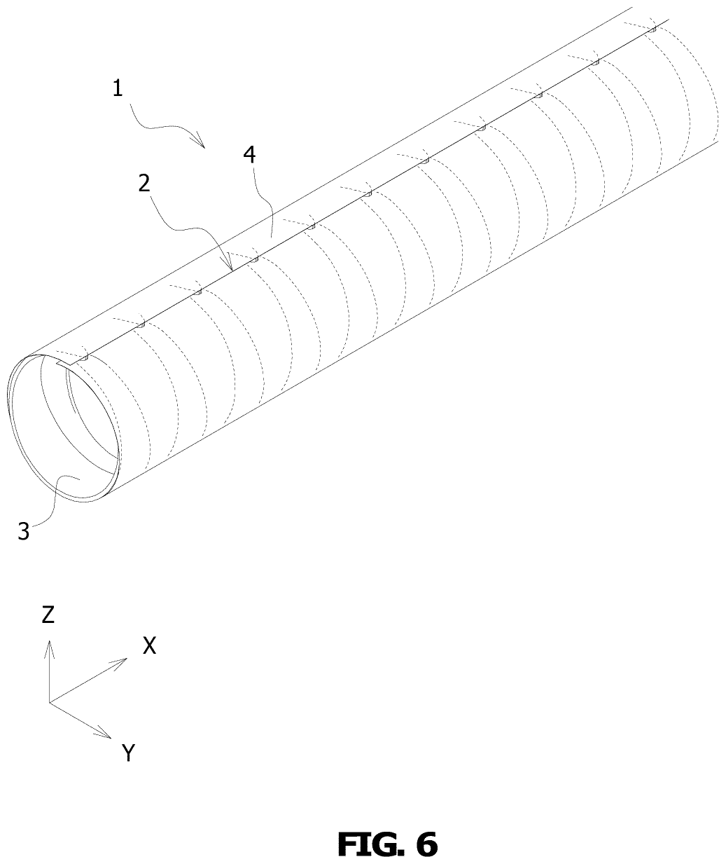

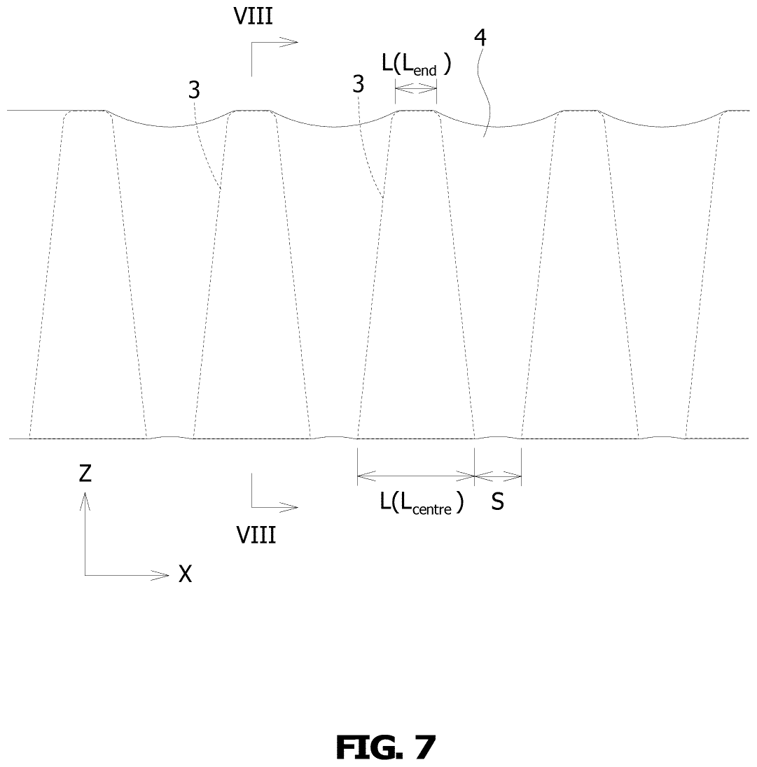

FIGS. 6 to 8 show a variation of the long article management conduit 1. In this example, the conduit 1 has a generally circular cross section. The features given with reference to FIGS. 1 to 5 can be equally applied to this variation.

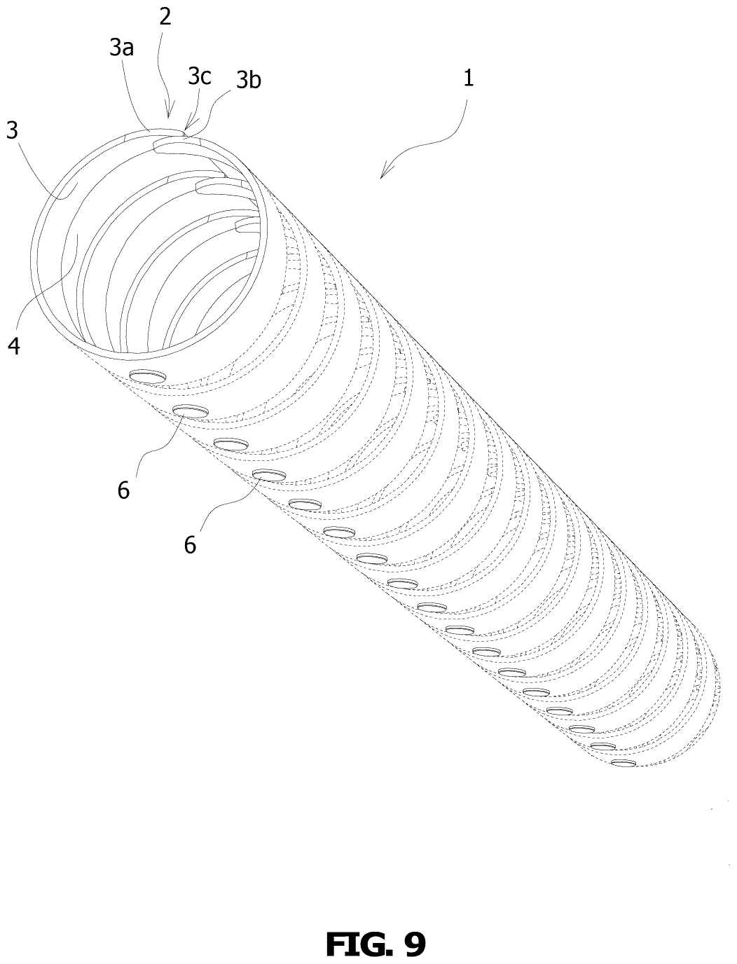

FIG. 9 shows a long article management conduit 1 according to an embodiment of the present invention. The conduit 1 comprises, like other example, a plurality of formed or pre-formed hoops 3 and a membrane 4. The membrane 4 is fastened to the outer surface of each hoop 3 by one or more rivets 6. The membrane 4 may be secured to the hoops 3 by any other means of fastening such as clips, sewing, loops, and tapes. Additionally, the membrane 4 may be bonded or welded to the hoops 3.

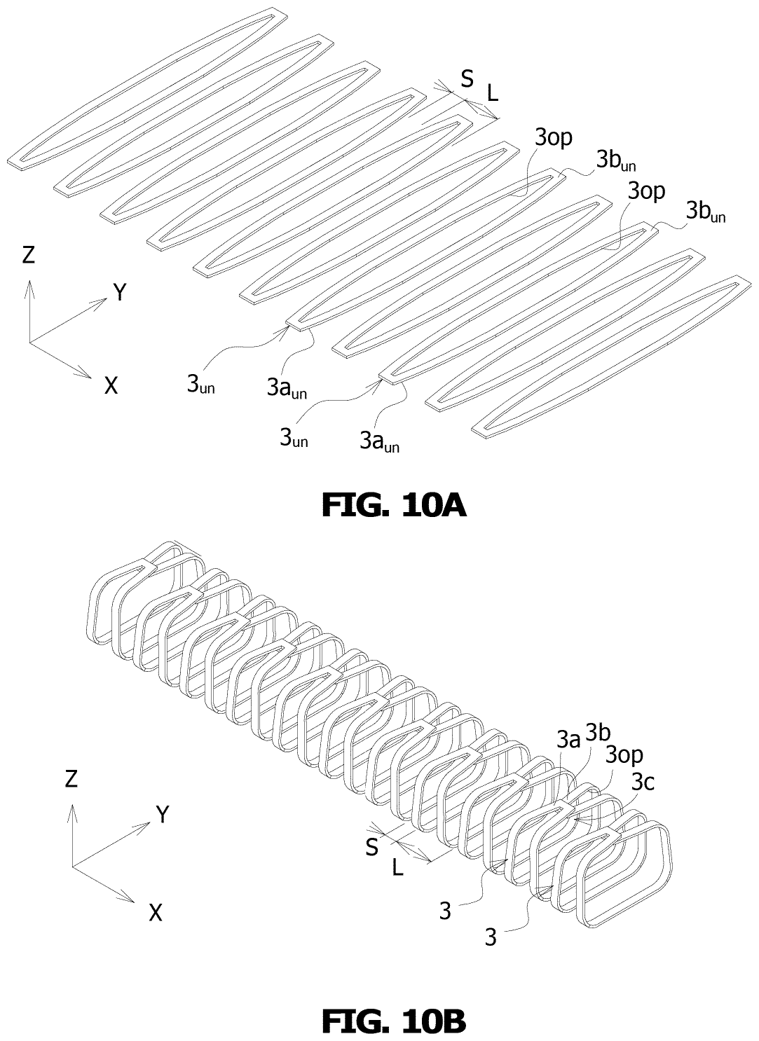

FIGS. 10A and 10B show unformed flat plate pieces 3ᵤₙ and formed hoops 3 for constructing another example long article management conduit (not shown). The long article management conduit comprises, like other examples, the plurality of hoops 3 arranged in series in the longitudinal direction X, and one or more membranes (not shown) attached to the hoops 3. In this example, one or more hoops 3 (flat plate pieces 3un) have one or more openings 3op through a wall thereof. Such an opening 3op allows for giving the opportunity to reduce weight and material of the long article management conduit. Further, such an opening 3op may allow for adjustment of the flexibility of the hoop 3 and thus of the conduit. Preferably, the opening 3op has a geometry similar to the contour of the flat plate piece 3ᵤₙ or hoop 3. In the example shown, since the flat plate piece 3un or hoop 3 has a substantially barrel or elliptical shape in which the depth (dimension L in the longitudinal direction X) is reduced toward to the width ends 3aᵤₙ, 3bᵤₙ, the opening 3op also has a substantially barrel or elliptical shape. In addition to, or in place of the openings 3op, one or more cutouts and/or one or more thinned wall portions may be provided in one or more hoops 3 (not shown).

FIGS. 11A and 11B show yet another example long article management conduit 1 comprising a plurality of hoops 3 with irregular shape, and membranes 4 attached to both of the inner and outer surfaces of the hoops 3. Alternatively, the membrane 4 may be provided on either the inner surface or outer surface of the hoop 3. In this example, each hoop 3 has a projection 3d extending outwardly from the discontinuous portion 3c. The hoop 3 may include an overlap portion at the discontinuous portion 3c. As such, the overlap portion locates at the middle section between the both ends 3a, 3b of the hoop 3. The projection 3d may be used as a grip when a user opens the split part 2.

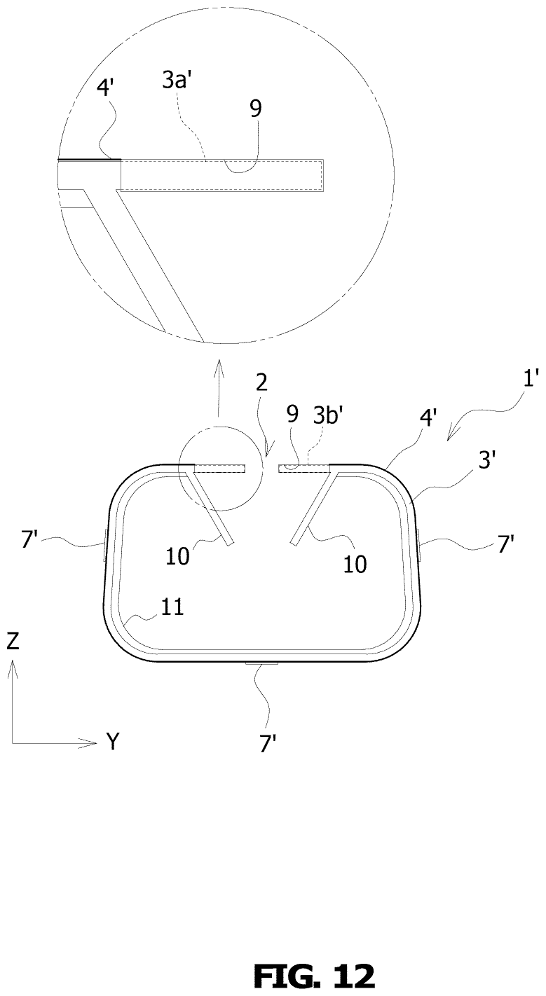

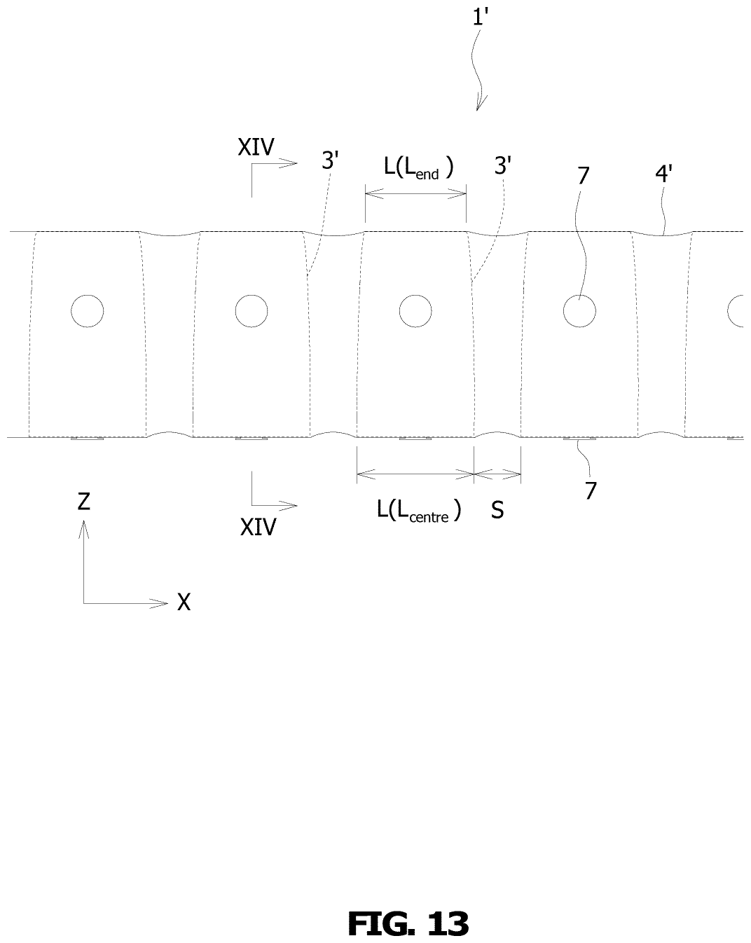

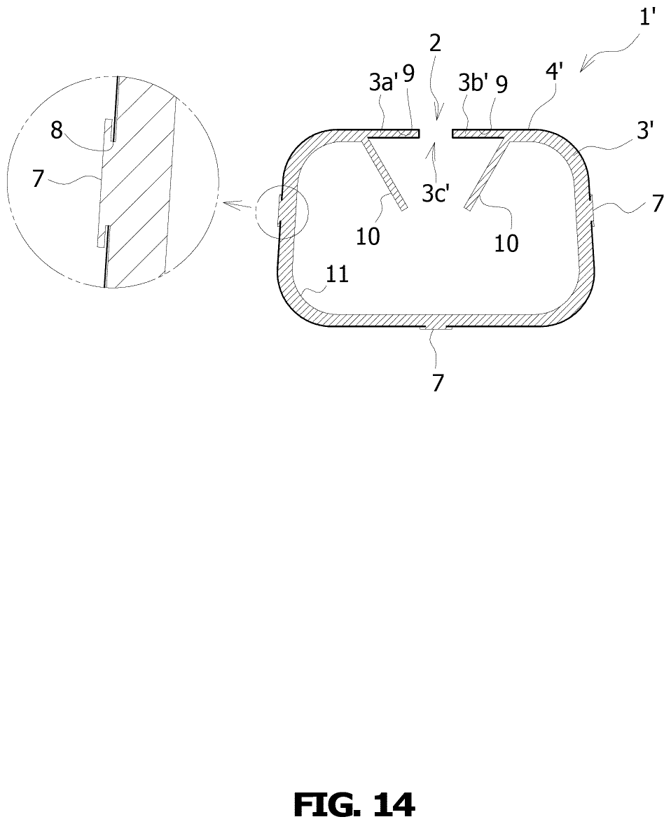

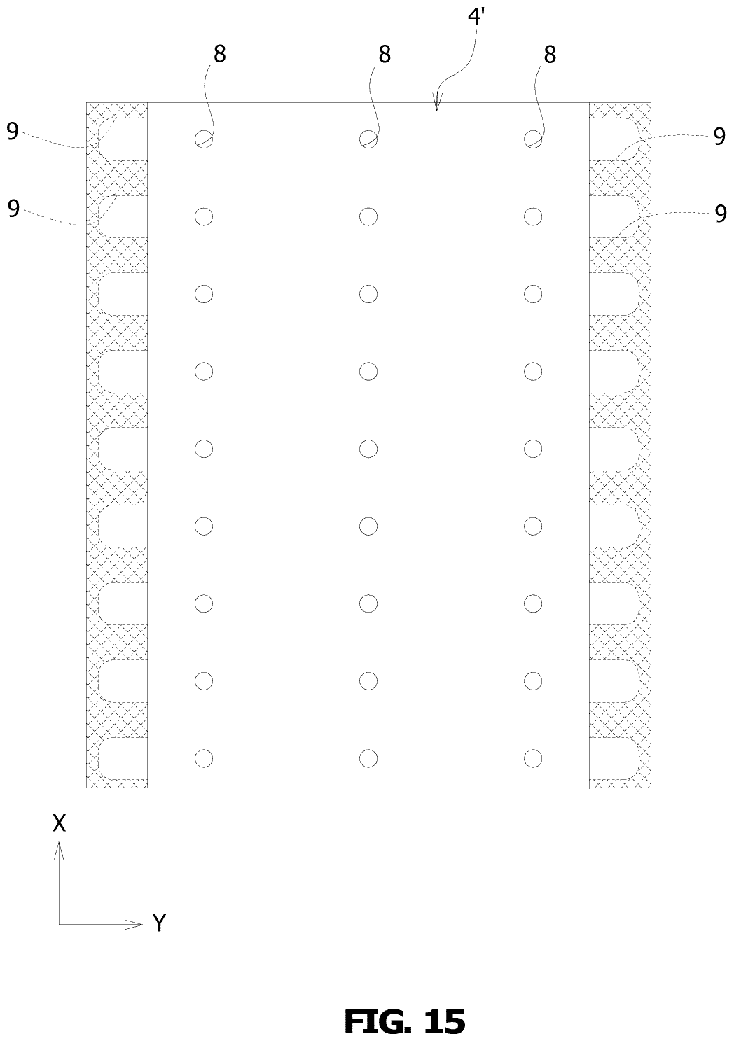

The following description is made with reference to FIGS. 12 to 15. FIG. 12 is a front view of a long article management conduit 1′ according to an embodiment of the present invention. FIG. 13 is a side view of the long article management conduit 1′ of FIG. 12. FIG. 14 is a cross-section view of the long article management conduit 1′ of FIG. 12 taken along line XIV-XIV in FIG. 13. FIG. 15 shows a backside of a membrane 4′ removed from the long article management conduit 1′ of FIG. 12. The “backside” is a side which is to face the outer surface of the hoops 3′ when assembled.

The long article management conduit 1′ comprises a plurality of hoops 3′ and a membrane 4′. The membrane 4′ is detachably attached to the outer surface of the hoops 3′. Each hoop 3′ is a pre-formed piece made by injection moulding, 3D printing, bending, or pressing, for example. Additionally, or alternatively, a second membrane (not shown) may be attached on the inner surfaces of the hoops 3′. The hoop 3′ includes one or more hooks 7 to detachably hold the membrane 4. In this example, three hooks 7 are provided on a bottom surface and both side surfaces of the hoop 3′.

The membrane 4′ include one or more holes 8 into which the one or more hooks 7 are inserted. Three holes 8 are provided in the example shown. Further, the membrane 4′ may include a plurality of pockets 9 into which the first and second ends 3a′, 3b′ of the hoops 3′ are inserted. The pockets 9 may be arranged at the folded edges of the membrane 4′ at the split part 2. The folded edges may be bonded and/or sewn, excluding the areas of pockets 9. The pockets 9 may extend partially across the membrane 4′ or all the way across creating one long pocket (not shown) where the hoops 3 can be fed through.

The hoop 3 may be provided with one or more lugs 10. The one or more lugs 10 are preferably located adjacent the ends 3a′, 3b′. The one or more lugs 10 preferably extend inward from the inner surface of the hoop 3′. Such lugs 10 may be used to retain long articles on the inside of the conduit 1′ to prevent the long articles falling out, particularly in the absence of an overlap portion in the hoop 3′.

The hoop 3 may include one or more reinforcing ribs 11. The reinforcing rib 11 may be arranged on the inner surface of the hoop 3. The reinforcing rib 11 preferably extends in a plane (Y-Z plane) perpendicular to the longitudinal direction X of the conduit 1′.

The features given with reference to FIGS. 1 to 11 can be equally applied to this embodiment as long as the membrane 4′ is detachable.

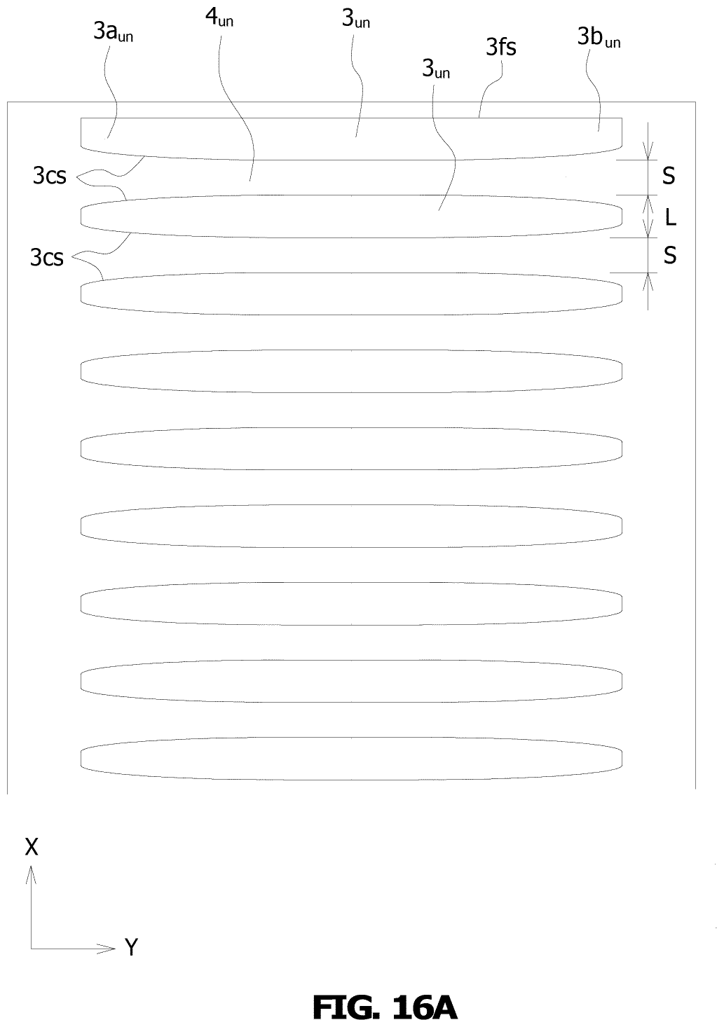

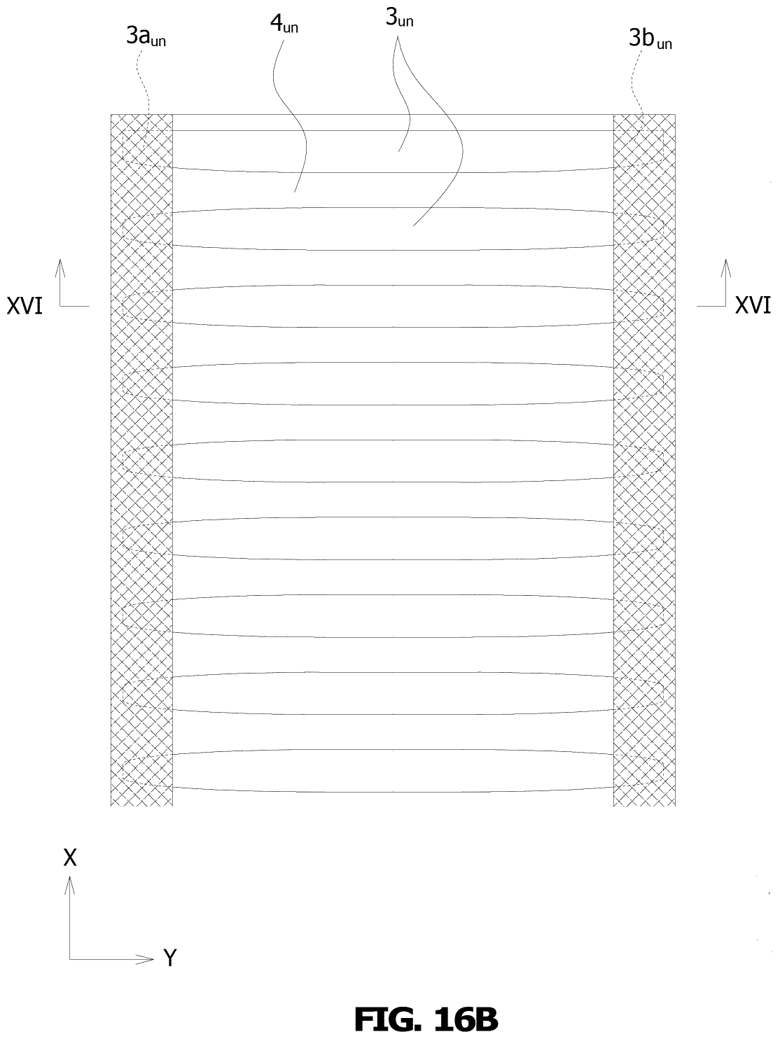

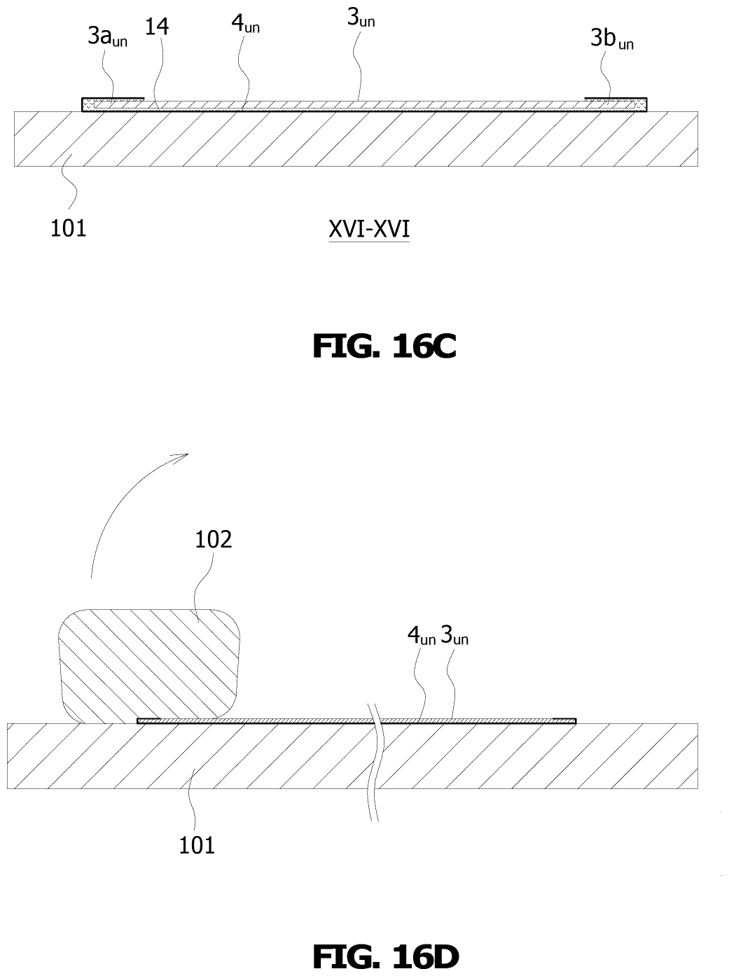

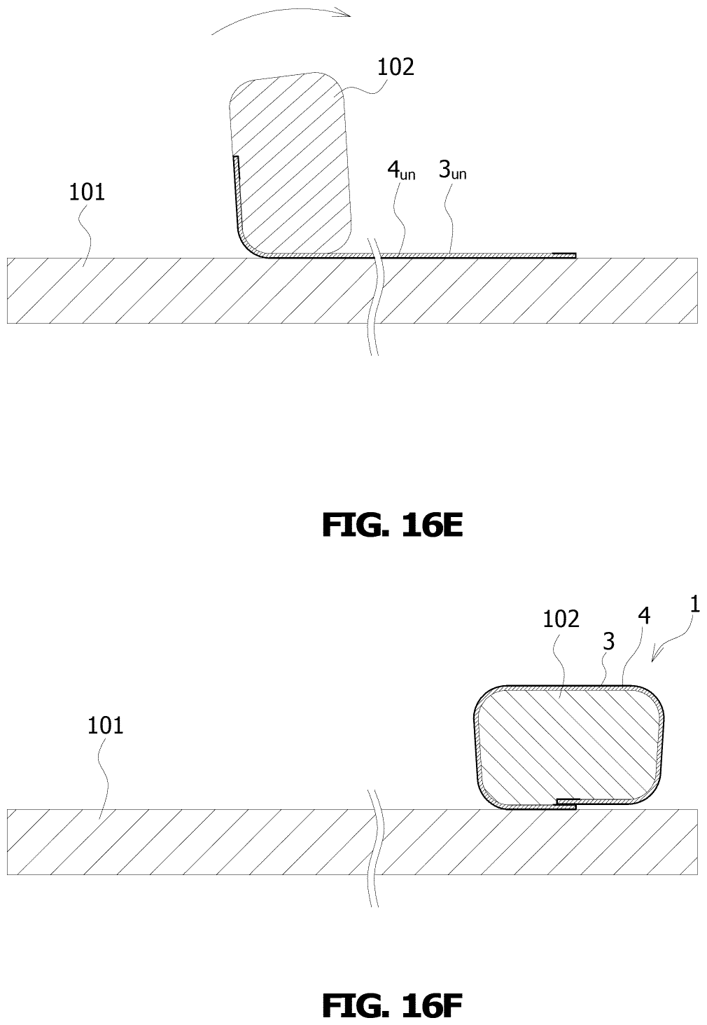

The following description is made with reference to FIGS. 16A to 16D. FIGS. 16A-16D illustrate a method for producing a long article management, according to an embodiment of the present invention.

In the example shown, the conduit 1 shown in FIG. 1 is produced according to this example method.

The method includes a step of providing a plurality of unformed flat plate pieces 3ᵤₙ. The flat plate pieces 3ᵤₙ may be tapered from the centre toward the first and second width ends 3aᵤₙ, 3bᵤₙ. The flat plate pieces 3ᵤₙ can also be a variety of shapes and sizes.

FIG. 16A shows a step of arranging the flat plate pieces 3ᵤₙ onto a flat membrane 4ᵤₙ side by side with a spacing S therebetween in a direction which is to be the longitudinal direction X (see FIG. 1). A second flat membrane (not shown) may be placed onto the flat plate pieces 3ᵤₙ which have been arranged side by side with the spacing S therebetween in the direction X so that the flat plate pieces 3ᵤₙ are between the two flat membranes 4ᵤₙ.

FIG. 16B shows that one or both width edges of the membrane 4ᵤₙ may be folded around the first and second width ends 3aᵤₙ, 3bᵤₙ of the flat plate pieces 3ᵤₙ.

FIG. 16C shows that an adhesive 14 may be provided between the membrane 4ᵤₙ and the flat plate pieces 3ᵤₙ. The adhesive 14 may be applied to the flat plate pieces and/or on the flat membrane before the flat plate pieces 3ᵤₙ are arranged on the membrane 4ᵤₙ. The flat plate pieces 3ᵤₙ and the membrane 4ᵤₙ are preferably unbonded or semi-bonded at the stage where the flat plate pieces 3ᵤₙ are not yet formed into hoop shapes. However, the flat plate pieces 3ᵤₙ may be fully bonded or welded to the membrane 4ᵤₙ at this stage.

FIGS. 16D to 16F show a step of forming the flat plate pieces 3ᵤₙ into hoop shapes around the direction which is to be the longitudinal direction X. The flat plate pieces 3ᵤₙ, or both flat plate pieces 3ᵤₙ and the membrane 4ᵤₙ, are heated on a support base 101 to soften, and rolled around a former 102. The former 102 may include an outer surface generally matching the inner surface of the conduit 1. The formed hoops 3 may be cooled on the former 102. The former 102 is then removed from either axial end of the formed conduit 1. Alternatively, the former 102 may be removed through the split part 2 by enlarging this part.

The heating may be done immediately before and/or during the formation. The heating means may be one or more heating lamps, resistance heaters, or the like. The heating means may be one or more electric heaters integrated within the support base 101 and/or the former 102. The heating means may include one or more top level heaters or surface heaters to heat at least the flat plate pieces 3ᵤₙ from above and/or below.

During this formation of the flat plate pieces 3ᵤₙ into the hoop shapes, the adhesive 14 is preferably cured. That is, the bonding and forming steps are made at the same. Surprisingly, this eliminates, or at least partially reduces, the shear that may occur in the adhesive 14 during the formation, thereby, an improved adhesive strength between the membrane 4 and the hoops 3 is achieved.

Alternatively, the flat plate pieces 3ᵤₙ may be welded to the membrane 4ᵤₙ during the formation of the flat plate pieces 3ᵤₙ into the hoop shapes.

The following description is directed to a method of producing a long article management conduit, according to another embodiment of the present invention. This method may be used to produce the conduit 1′ shown in FIGS. 12 to 15.

The method comprises a step of providing the plurality of pre-formed hoops 3′, each having first and second ends 3a′, 3b′ so as to have a discontinuous portion 3c′.

The method comprises a step of detachably attaching the pre-formed hoops 3′ onto the membrane 4′ so that the pre-formed hoops 3′ are arranged side by side with a spacing S therebetween in a direction which is to be the longitudinal direction X, thereby the pre-formed hoops 3′ are linked to each other in series in the longitudinal direction X. The method may include engaging the one or more holes 8 of the membrane 4′ with the one or more hooks 7 of the pre-formed hoop 3′.

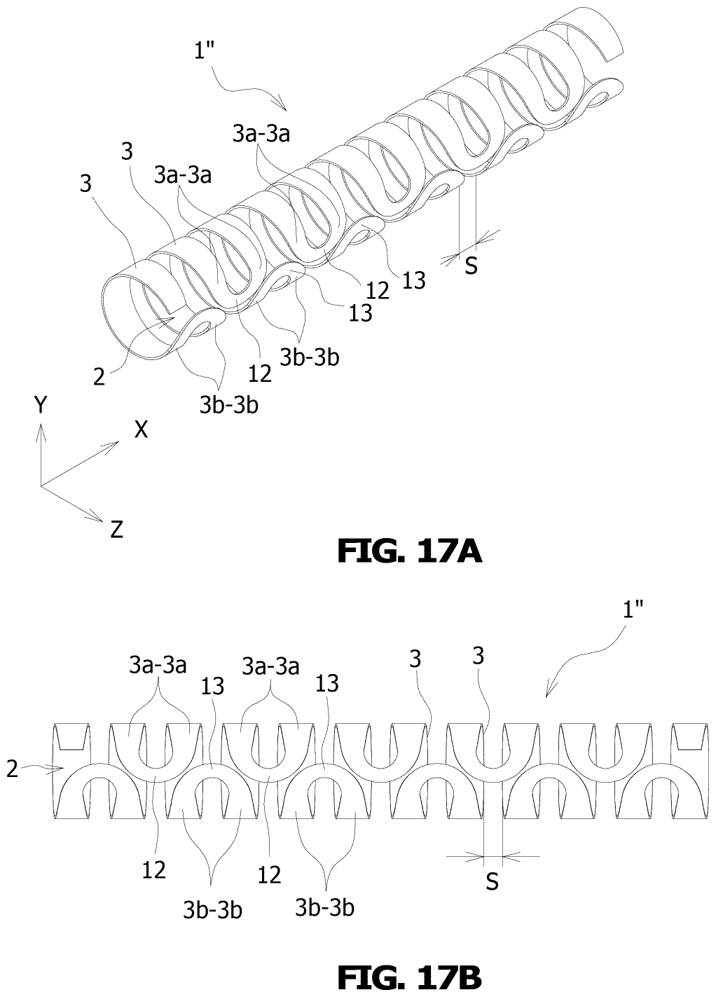

In FIGS. 17A and 17B another exemplary embodiment of the long article management conduit according to the invention is shown. The same parts are provided with the same reference numerals and are not described again in detail here. The conduit 1″ has once again the plurality of hoops 3, each having first and second ends 3a, 3b so as to have the discontinuous portion at the split part 2, and arranged side by side with the spacing S therebetween in the longitudinal direction X. In this example, said membrane for linking the adjacent hoops in series in the longitudinal direction is not required. Instead of the membrane, the conduit 1″ has a plurality of connecting webs 12 which connect every other set of two first ends 3a-3a adjacent to each other in the longitudinal direction X. The conduit 1″ also has a plurality connecting webs 13 which connect every other set of two second ends 3b-3b adjacent to each other in the longitudinal direction X. The first connecting webs 12 and the second connecting webs 13 are located alternatively in the longitudinal direction X. With these webs 12, 13, said spacing S is maintained between the hoops adjacent to each other in the longitudinal direction X.

The conduit 10″ according to this embodiment may be configured without said membrane, and thus manufactured in fewer processes and material. However, one or more membranes as discussed before may also be provided on inner surfaces and/or outer surfaces of the hoops so that articles inserted in the conduit 1″ are completely covered. Such membrane may provide a protection for the articles inside the conduit 1″.

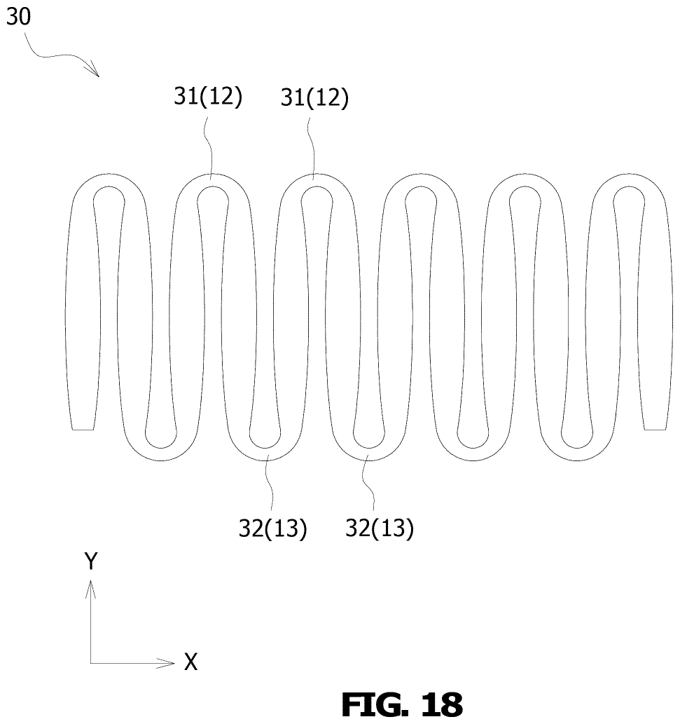

In FIG. 18 an example unformed flat strip material for producing the conduit 1″ shown in FIGS. 17A and 17B is shown. The flat strip 30 may be made of deformable material such as plastics and metals. The unformed flat strip 30 may be made of thermoplastic resin, biodegradable plastics, plant based resins. The flat strip 30 extends in a meander-like fashion and thus has a plurality of turning points 31, 32 on both sides. The flat strip 30 is then formed into a hoop shape around the longitudinal direction X so that the turning points 31 on one side and the turning points 32 on the other side are located alternately in the longitudinal direction X, by using a former as discussed with reference to FIGS. 16D to 16F. The turning points 31 will be the first connecting webs 12 in the conduit 10″, and the turning points 32 will be the second connecting webs 13 in the conduit 10″.

Of course, changes and modifications to the above examples of the invention should be readily apparent to those having ordinary skill in the art, without departing from the spirit or scope of the invention as claimed.

1-31. (canceled)

32. A long article management conduit with a split part extending in a longitudinal direction thereof, comprising:
a plurality of hoops, each having first and second ends to have a discontinuous portion at the split part and arranged side by side with a spacing therebetween in the longitudinal direction.

33. The long article management conduit of claim 32, further comprising one or more membranes attached on an outer and/or inner surface of the hoops so that the hoops are linked to each other in series in the longitudinal direction,
wherein each of the hoops includes one or more hooks so that the one or more membranes are detachably attached to the hoops.

34. The long article management conduit of claim 32, further comprising:
a plurality of first connecting webs which connect every other set of two first ends adjacent to each other in the longitudinal direction;
a plurality of second connecting webs which connect every other set of two second ends adjacent to each other in the longitudinal direction;
wherein the first connecting web and the second connecting web are located alternately in the longitudinal direction, and the spacing is provided between the hoops adjacent to each other in the longitudinal direction; and
wherein the first connecting web and the second connecting web overlap when viewed in the longitudinal direction.

35. The long article management conduit of claim 33, wherein the membrane is bonded, welded, or sewn to the hoops.

36. The long article management conduit of claim 33, wherein the membrane is fastened to the hoops with fasteners.

37. The long article management conduit of claim 32, wherein each of the hoops is made of materials selected from the group consisting of thermoplastic resin, biodegradable plastics, plant based resins, and metal.

38. The long article management conduit of claim 32, wherein each of the hoops is a formed piece;
wherein the first and second ends of each of the hoops overlap each other in a circumferential direction; and/or
wherein the dimension of each of the hoops measured in the longitudinal direction is in the range of 10% to 200% of the diameter or widest width of the conduit; and/or
wherein the dimension of each of the hoops measured in the longitudinal direction decreases toward the first and second ends; and/or
wherein at least one hoop has one or more openings, one or more cutouts, and/or one or more thinned wall portions; and/or
wherein the each of the hoops includes one or more reinforcing ribs.

39. The long article management conduit of claim 33, wherein the membrane is made from a material selected from the group consisting of: fabric, nonwoven fabric, natural or synthetic fibre, paper, synthetic resin film, artificial leather, natural leather, and any other film either natural or synthetic.

40. The long article management conduit of claim 33, wherein the membranes are provided on the outer and/or inner surface of each hoop.

41. The long article management conduit of claim 33, wherein one or both edges of the membrane at the split part are folded to cover the first and/or second ends of each hoop.

42. The long article management conduit of claim 33, wherein one or both edges of the membrane at the split part are covered with covering strips.

43. The long article management conduit of claim 33, wherein one or both edges of the membrane at the split part are finished with a sewn hem.

44. The long article management conduit of claim 33, wherein one or both edges of the membrane at the split part include a plurality of pockets into which the first and/or second ends of the hoops, or the entire hoop, are inserted.

45. The long article management conduit of claim 32, wherein the spacing is in the range of 0.5 to 100% of the diameter or widest width of the conduit; and/or
wherein the spacing is in the range of 0.5 mm to 100 mm; and/or
wherein the plurality of hoops are resiliently deformable.

46. A method for producing a long article management conduit with a split part continuously extending in a longitudinal direction thereof, comprising the steps of:
providing a plurality of flat plate pieces;
arranging the plurality of flat plate pieces on a first membrane side by side with a spacing therebetween in a longitudinal direction;
bonding, welding, sewing or fastening the flat plate pieces to the first membrane; and
creating a plurality of hoops by forming the flat plate pieces into hoop shapes around the longitudinal direction.

47. The method of claim 46, further comprising the steps of:
arranging a second membrane over the first membrane so that the plurality of the flat plate pieces are between the first and second membranes; and
bonding, welding, sewing or fastening the second membrane to the flat plate pieces; and/or
wherein the forming step is performed during or after the bonding or welding step; and/or
wherein the plurality of hoops are resiliently deformable.

48. A method for producing a long article management conduit with a split part continuously extending in a longitudinal direction thereof, comprising the steps of:
providing a plurality of pre-formed hoops, each having first and second ends to have a discontinuous portion;
detachably attaching the pre-formed hoops onto a membrane so that the pre-formed hoops are arranged side by side with a spacing therebetween in a longitudinal direction; and
wherein the pre-formed hoops are linked to each other in series in the longitudinal direction.

49. The method of claim 48, wherein the pre-formed hoops include one or more hooks, and the membrane includes one or more holes into which the hooks are inserted.

50. The method of claim 48, wherein the plurality of pre-formed hoops are resiliently deformable.

51. A method for producing a long article management conduit with a split part continuously extending in a longitudinal direction thereof, comprising the steps of:
providing a flat strip which extends in a meander-like fashion and thus has a plurality of turning points on both sides; and
creating a plurality of hoops by forming the flat strip into a hoop shape around the longitudinal direction so that the turning points on one side and the turning points on the other side are located alternately in the longitudinal direction.
